(19) United States
(12) Patent Application Publication
(10) Pub. No.: US 2026/0246039 A1
(43) Pub. Date: Aug. 20, 2026

(54) GASKET, CYLINDRICAL BATTERY, AND CYLINDRICAL BATTERY MANUFACTURING METHOD

(71) Applicant: Panasonic Energy Co., Ltd., Osaka (JP)

(72) Inventor: Naoto KUNOIKE, Osaka (JP)

(21) Appl. No.: 19/157,225

(22) PCT Filed: Feb. 9, 2024
(86) PCT No.: PCT/JP2024/004459

§ 371 Date: Aug. 15, 2025

(30) Foreign Application Priority Data
Mar. 8, 2023 (JP) 2023-035621

(51) Int. Cl. H01M 50/186; H01M 50/107; H01M 50/152; H01M 50/167; H01M 50/184

(52) U.S. Cl. CPC H01M 50/186; H01M 50/107; H01M 50/152; H01M 50/167; H01M 50/184

(57) ABSTRACT

A gasket of a cylindrical battery comprises: a cylindrical portion having an annular groove provided on the outer circumferential surface thereof; and an annular portion extending radially inward from one end on one side in an axial direction of the cylindrical portion. If a sealing body of the cylindrical battery is attached to the gasket so as to abut the annular portion, in the axial direction of the cylindrical portion, the annular groove is provided in a range of the cylindrical portion extending from a first position, which corresponds to a surface on the other side of a peripheral portion of the sealing body, to a second position which is 1 mm apart on the other side in the axial direction.

### DESCRIPTION

### Technical Field

The present disclosure relates to a gasket for a cylindrical battery, the cylindrical battery, and a cylindrical battery manufacturing method.

### Background Art

Cylindrical batteries comprise an electrode assembly, a bottomed cylindrical outer can that houses the electrode assembly, a sealing assembly that seals an opening portion of the outer can, and a gasket that is held between the outer can and a sealing portion (see, for example, Patent Literature 1). A cylindrical portion of the outer can has a grooved portion and an annular shoulder portion. The grooved portion is formed by recessing part of the cylindrical portion inward in a radial direction. The shoulder portion is formed so as to extend inward in the radial direction when an end portion of the cylindrical portion on an opening side is bent inward and crimped to a circumferential edge portion of the sealing assembly. The sealing assembly is held between the shoulder portion and the grooved portion through the gasket and fixed to the outer can by the crimping.

### CITATION LIST

### Patent Literature

PATENT LITERATURE 1: Japanese Unexamined Patent Application Publication No. Hei 09-274923

### SUMMARY

At a corner portion of the outer can that is adjacent to a tip portion of the outer can extending inward in the radial direction, tensile residual stress is generated during the crimping. The corner portion also receives a large force from the gasket that is compressed during the crimping. Therefore, damage tends to occur in the corner portion. Accordingly, it is an advantage of the present disclosure to provide a gasket, a cylindrical battery, and a cylindrical battery manufacturing method, capable of suppressing the occurrence of damage in a corner portion of an outer can, the corner portion being adjacent to a tip portion of the outer can extending inward in the radial direction.

In order to accomplish the above object, a gasket according to the present disclosure is a gasket for a cylindrical battery, comprising: a cylindrical portion having an annular groove formed on an outer circumferential surface; and a circular portion extending inward in a radial direction from one end portion of the cylindrical portion on one side in an axial direction, wherein an annular groove is provided within a range from a first position to a second position in the cylindrical portion, the first position corresponding to another side surface of a circumferential edge portion of the sealing assembly, the second position being 1 mm away toward the other side from the first position in the axial direction of the cylindrical portion.

A cylindrical battery according to the present disclosure comprises: an electrode assembly having a positive electrode and a negative electrode wound through a separator; a bottomed cylindrical outer can that houses the electrode assembly; and a sealing assembly that is crimped and fixed to an opening portion of the outer can through a gasket, wherein the gasket has an annular groove provided in a range including at least part of a facing portion that faces a corner portion of the outer can, the corner portion being adjacent to a tip portion of the outer can extending inward in a radial direction.

The gasket, the cylindrical battery, and the cylindrical battery manufacturing method according to the present disclosure can suppress the occurrence of damage in the corner portion of the outer can, the corner portion being adjacent to the tip portion of the outer can that extends inward in the radial direction.

### BRIEF DESCRIPTION OF DRAWING

FIG. 1 is an axial sectional view of a cylindrical battery according to one embodiment of the present disclosure.

FIG. 2 is an enlarged sectional view showing the vicinity of a shoulder portion in FIG. 1.

FIG. 3 is a sectional view of a gasket before assembling of the battery.

### DESCRIPTION OF EMBODIMENTS

Hereinafter, an embodiment of a cylindrical battery according to the present disclosure will be described in detail with reference to the drawings. Here, the cylindrical battery of the present disclosure may be a primary battery or a secondary battery. The cylindrical battery may also be a battery using an aqueous electrolyte or a battery using a non-aqueous electrolyte. As a cylindrical battery 10 as one embodiment, a non-aqueous electrolyte secondary battery (lithium-ion battery) using a non-aqueous electrolyte is illustrated below, though the cylindrical battery of the present disclosure is not limited thereto, and the electrolyte may be an aqueous electrolyte.

It is assumed from the beginning that a new embodiment is constructed by appropriately combining characteristic portions of the embodiment or modifications as will be described below. In the embodiment below, like component members are designated by like reference signs to omit redundant explanation. The plurality of drawings also include schematic drawings, and throughout the different drawings, dimensional ratios, such as length, width, and height, do not necessarily match. In this specification, the cylindrical battery 10 on the side of a sealing assembly 19 in an axial direction (height direction) is defined as “upper side”, and an outer can 20 on the side of a bottom portion 20A in the axial direction is defined as “lower side”. Moreover, among the component members described below, those not included in an independent claim representing the highest-level concept are optional component members and are not essential component members. The present disclosure is also not limited to the embodiment and its modifications disclosed, and various improvements and changes are possible without departing from the scope of the Claims of the present invention and any equivalents thereof.

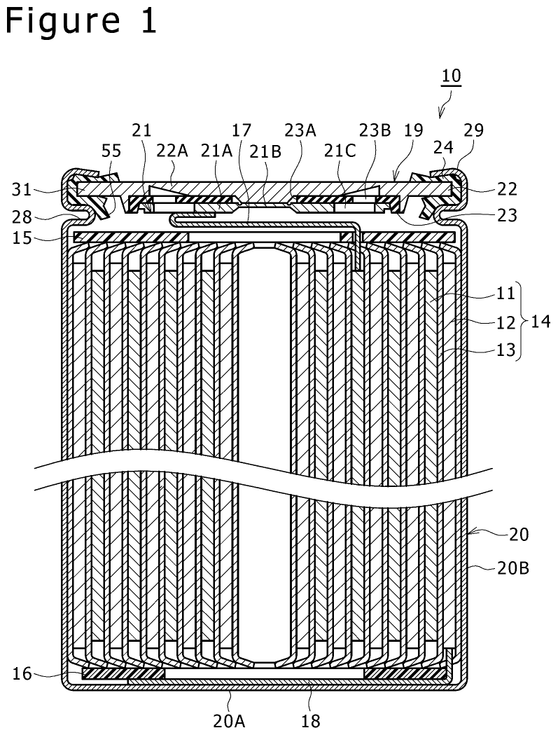

FIG. 1 is an axial sectional view of the cylindrical battery 10 according to one embodiment of the present disclosure. As shown in FIG. 1, the cylindrical battery 10 comprises an electrode assembly 14, a non-aqueous electrolyte, the bottomed cylindrical outer can 20 that houses the electrode assembly 14 and the non-aqueous electrolyte, and the sealing assembly 19 that seals the opening of the outer can 20. The electrode assembly 14 includes a positive electrode 11, a negative electrode 12, and separators 13 interposed between the positive electrode 11 and the negative electrode 12. The electrode assembly 14 has a winding structure in which the positive electrode 11 and the negative electrode 12 are wound through the separators 13. The outer can 20 is a bottomed cylindrical container having the bottom portion 20A and a cylindrical portion 20B.

The non-aqueous electrolyte contains, for example, non-aqueous solvent and electrolyte salt dissolved in the non-aqueous solvent. As the non-aqueous solvent, there may be used, for example, esters, ethers, nitriles, amides, and mixed solvent of two or more of the group consisting of these. The non-aqueous solvents may contain halogen substitution products in which at least a portion of hydrogen in these solvents is substituted with halogen atoms such as fluorine. The non-aqueous electrolyte is not limited to liquid electrolyte, and may be solid electrolyte using gel like polymers or the like. As the electrolyte salt, lithium salt such as LiPF₆ is used.

The electrode assembly 14 has the long-shaped positive electrode 11, the long-shaped negative electrode 12, and two long-shaped separators 13. The electrode assembly 14 also has a positive electrode lead 17 joined to the positive electrode 11 and a negative electrode lead 18 joined to the negative electrode 12 as electrode leads. In order to suppress lithium deposition, the negative electrode 12 is formed with a dimension slightly larger than the positive electrode 11. The two separators 13 are formed with a dimension that is at least slightly larger than the positive electrode 11 and are arranged, for example, to hold the positive electrode 11 therebetween.

The positive electrode 11 has a positive electrode core and a positive electrode mixture layer formed on both the surfaces of the positive electrode core. As the positive electrode core, there may be used a foil made of metal that is stable in a potential range of the positive electrode 11, such as aluminum and aluminum alloy, a film with the metal arranged on its surface layer, or the like. The positive electrode mixture layer contains a positive electrode active material, a conductive agent such as acetylene black, and a binding agent made of polyvinylidene fluoride (PVdF) or the like. The positive electrode 11 can be fabricated by, for example, coating the positive electrode core with positive electrode mixture slurry containing a positive electrode active material, a conductive agent, a binding agent or the like, drying the coating, and then compressing the coating to form a positive electrode mixture layer on both the surfaces of the positive electrode core.

As the positive electrode active material, lithium-transition metal composite oxides are used, for example. Examples of metal elements contained in the lithium-containing metal composite oxides may include Ni, Co, Mn, Al, B, Mg, Ti, V, Cr, Fe, Cu, Zn, Ga, Sr, Zr, Nb, In, Sn, Ta, and W. One suitable example of the lithium-containing metal composite oxides is lithium metal composite oxides containing at least one of the group consisting of Ni, Co, and Mn. Specific examples thereof may include composite oxides containing Ni, Co and MN, and composite oxides containing Ni, Co and Al.

The negative electrode 12 has a negative electrode core and a negative electrode mixture layer formed on both the surfaces of the negative electrode core. As the negative electrode core, there may be used a foil made of metal that is stable in a potential range of the negative electrode 12, such as copper or copper alloy, a film with the metal arranged on its surface layer, or the like. The negative electrode mixture layer contains a negative electrode active material and a binding agent such as styrene-butadiene rubber (SBR). The negative electrode 12 can be fabricated by, for example, coating the negative electrode core with negative electrode mixture slurry containing a negative electrode active material, a binding agent, or the like, drying the coating, and then compressing the coating to form a negative electrode mixture layer on both the surfaces of the negative electrode core.

As the negative electrode active material, there may be used, for example, natural graphite such as flake graphite, massive graphite, and earthy graphite, and artificial graphite such as massive artificial graphite, and graphitized mesophase carbon microbeads. As the negative electrode active material, there may be used metal that alloys with lithium such as Si and Sn, alloy containing the metal, and compounds containing the metal, and these may be used together with graphite. One suitable example of such an active material is a Si-containing material in which Si particles are dispersed in a silicate phase, such as an SiO₂ phase or a lithium silicate phase, or in an amorphous carbon phase.

Insulating plates 15 and 16 are arranged above and below the electrode assembly 14, respectively. In the example shown in FIG. 1, the positive electrode lead 17 attached to the positive electrode 11 extends toward the sealing assembly 19 through a through-hole of the insulating plate 15, and the negative electrode lead 18 attached to the negative electrode 12 extends toward the bottom portion 20A of the outer can 20 along the outside of the insulating plate 16. The positive electrode lead 17 is connected by welding or the like to an inner surface of the sealing assembly 19 that faces the inside of the outer can 20, so that the sealing assembly 19 serves as a positive electrode terminal. The negative electrode lead 18 is connected by welding or the like to an inner surface of the bottom portion 20A of the outer can 20, so that the outer can 20 serves as a negative electrode terminal.

Between the outer can 20 and the sealing assembly 19, a gasket 24 is provided to secure the sealability inside the battery and the insulation performance between the outer can 20 and the sealing assembly 19. The cylindrical portion 20B includes an annular grooved portion 28 and an annular shoulder portion 29. The grooved portion 28 is formed by recessing part of the cylindrical portion 20B inward in the radial direction by spinning. The shoulder portion 29 is formed so as to extend to the inside in the radial direction when an upper end portion of the cylindrical portion 20B is bent radially inward and crimped to a circumferential edge portion 31 of the sealing assembly 19. The sealing assembly 19 is held between the shoulder portion 29 and the grooved portion 28 through the gasket 24 and fixed to the outer can 20 by the crimping.

The sealing assembly 19 is a disc-shaped member comprising a current cutoff mechanism. The sealing assembly 19 has a structure formed by stacking, in order from the side of the electrode assembly 14, an internal terminal plate 21, an insulating plate 23, and a rupture plate 22. The internal terminal plate 21 is a metal plate including a thick-walled annular portion 21A to be connected to the positive electrode lead 17, and a thin-walled central portion 21B that is disconnected from the annular portion 21A or detached from the rupture plate 22 when the internal pressure of the battery exceeds a predetermined threshold. In the annular portion 21A, a vent hole 21C is formed.

The rupture plate 22 is arranged so as to face the internal terminal plate 21 through the insulating plate 23. In the insulating plate 23, an opening portion 23A is formed in the center portion in the radial direction, and a vent hole 23B is formed at a portion overlapping with the vent hole 21C of the internal terminal plate 21. The rupture plate 22 has a vent portion 22A that breaks when the internal pressure of the battery exceeds the predetermined threshold, and the vent portion 22A is connected by welding or the like to the central portion 21B of the internal terminal plate 21 through the opening portion 23A of the insulating plate 23. The insulating plate 23 insulates between the annular portion 21A and the vent portion 22A.

The vent portion 22A includes a lower projection that projects to the inside of the battery and that is provided in a radially center portion, and a thin-walled portion formed around the lower projection. The thickness of the thin-walled portion is smaller toward the outer side in the radial direction. When electrical connection is established between the internal terminal plate 21 connected to the positive electrode lead 17 and the rupture plate 22, a current path is formed from the electrode assembly 14 to the rupture plate 22.

When the internal pressure of the cylindrical battery 10 increases, the vent portion 22A is inverted so as to project to the upper side in the axial direction, by using an annular end portion on the radially outer side, which is less rigid in the thin-walled portion, as a supporting point. At the same time as this inversion, the central portion 21B is disconnected from the annular portion 21A or detached from the vent portion 22A, which cuts off the current path. As the internal pressure of the battery increases further, the annular end portion in the thin-walled portion breaks and a gas outlet is formed.

Note that the structure of the sealing assembly 19 is not limited to the structure shown in FIG. 1. For example, the sealing assembly 19 may be configured with only the rupture plate. Alternatively, the sealing assembly 19 may have a stacked structure including two rupture plates, and may have a convex sealing assembly cap that covers the rupture plates.

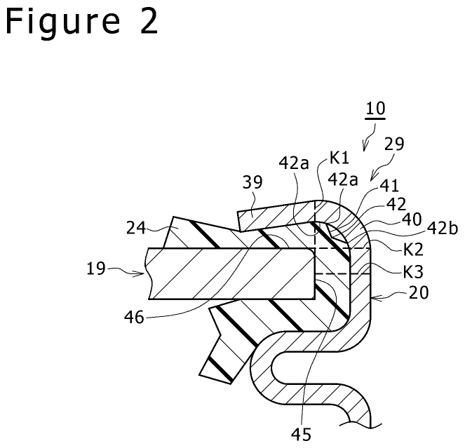

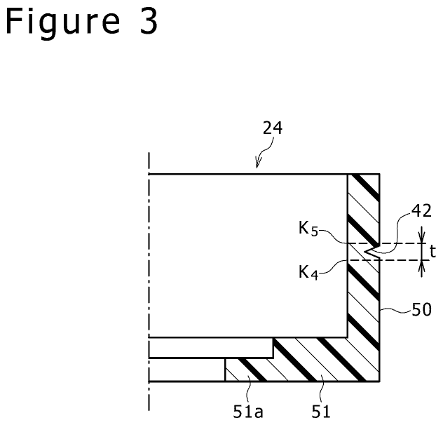

The structure of the outer can 20 is described below in detail with reference to FIGS. 2 and 3. FIG. 2 is an enlarged sectional view showing the vicinity of the shoulder portion 29 in FIG. 1. FIG. 3 is a sectional view of the gasket 24 before assembling of the battery. As shown in FIG. 2, the gasket 24 has an annular groove 42 provided in a range including at least part of a facing portion 41 that faces a corner portion 40 of the outer can 20, the corner portion 40 being adjacent to a tip portion 39 of the outer can 20 extending inward in the radial direction.

The corner portion 40 is a portion located between a first place K1 and a second place K2 in the outer can 20, the first place K1 overlapping with a radially outer circumferential end 45 of the sealing assembly 19 on the upper side in the axial direction, the second place K2 overlapping with an upper surface 46 of the circumferential edge portion of the sealing assembly 19 in the radial direction. The outer can 20 having the annular groove 42 can be fabricated by following procedures.

First, the gasket 24 is prepared so as to have a cross-sectional shape before assembling of the battery as shown in FIG. 3. As shown in FIG. 3, the gasket 24 comprises a cylindrical portion 50 provided with the annular groove 42 on its outer peripheral surface and a circular portion 51 extending inward in the radial direction from one end portion of the cylindrical portion 50 on one side in the axial direction (a lower end portion in the axial direction).

When the sealing assembly 17 of the cylindrical battery 10 is mounted on the gasket 24 so as to be in contact with the circular portion 51, the annular groove 42 is provided within a range from a first position K4 to a second position K5 in the cylindrical portion 50, the first position K4 corresponding to another side surface (upper surface 46) of the circumferential edge portion 31 of the sealing assembly 17, the second position K5 being 1 mm away toward the other side, in the axial direction of the cylindrical portion 50. In FIG. 3, t represents a length from the first position K4 to the second position K5 in the axial direction. t is equal to 1 mm.

In the example shown in FIG. 3, the annular groove 42 is a V-shaped groove in cross section, though the shape of the annular groove 42 in cross section may be any shape, such as a U-shape or an arc-shape, for example. A thin-walled portion 51a, which is formed at a radially inner end portion of the circular portion 51 and is thinner than a radially outer end portion of the circular portion 51, constitutes a cover portion 55 (see FIG. 1), which covers a radially inner tip of the grooved portion 28 in the cylindrical battery 10. Constituting the cover portion 55 can reliably prevent a short circuit between the outer can 20 and the sealing assembly 19.

Next, the grooved portion 28 is formed by recessing part of the cylindrical portion 20B inward in the radial direction by spinning. Then, the sealing assembly 19 and the gasket 24 are arranged on the grooved portion 28 so that the gasket 24 is located between the outer can 20 and the sealing assembly 19. After that, the upper end portion of the cylindrical portion 20B is bent radially inward and is crimped to the circumferential edge portion 31 of the sealing assembly 19, by which the cylindrical battery 10 is fabricated.

According to the cylindrical battery 10, the gasket 24 has the annular groove 42 provided in a range including at least part of the facing portion 41 that faces the corner portion 40 of the outer can 20, the corner portion 40 being adjacent to the tip portion 39 of the outer can 20 extending inward in the radial direction. Therefore, when the upper end portion of the outer can 20 is crimped to the circumferential edge portion 31 of the sealing assembly 19, the force that the corner portion 40 of the outer can 20 receives from the gasket 24 can be reduced, and the occurrence of damage in the corner portion 40 of the outer can 20 can be suppressed.

Moreover, in the cylindrical battery 10, the annular groove 42 is provided only in part of the outer circumferential surface of the cylindrical portion 50 of the gasket 24, which makes it possible to enhance the sealability of the outer can 20 and the sealing assembly 19 held by the gasket 24, and to reliably prevent creep-up of the non-aqueous electrolyte and infiltration of foreign matter (for example, moisture) from the outside.

When the depth of a deepest portion of the annular groove 42 in the gasket 24 before assembling of the battery is greater than or equal to 10% of the thickness of the cylindrical portion 50, the force that the corner portion 40 receives from the gasket 24 can be effectively reduced, which provides excellent effect of suppressing the occurrence of damage in the corner portion 40 of the outer can 20. When the depth of the deepest portion of the annular groove 42 is less than or equal to 40% of the thickness of the cylindrical portion 50, excellent sealability of the gasket 24 is achieved.

With reference to FIG. 2, when a lower end 42b of the annular groove 42 is located on the side higher in the axial direction than an axial midpoint K3 at the circumferential edge portion 31 of the sealing assembly 19, the sealability of the cylindrical battery 10 becomes higher. Moreover, when an end 42a of the annular groove 42 on the tip side of the gasket 24 is located in the facing portion 41, the sealability of the cylindrical battery 10 becomes higher. As shown in FIG. 2, when the entire annular groove 42 is located in the facing portion 41 in particular, the occurrence of damage in the corner portion 40 of the outer can 20 can be effectively suppressed and the sealability of the cylindrical battery 10 can also be enhanced.

### REFERENCE SIGNS LIST

10 Cylindrical battery, 11 Positive electrode, 12 Negative electrode, 13 Separator, 14 Electrode assembly, 15, 16, 23 Insulating plate, 17 Positive electrode lead, 18 Negative electrode lead, 19 Sealing assembly, 20 Outer can, 20A Bottom portion, 20B Cylindrical portion, 21 Internal terminal plate, 21A Annular portion, 21B Central portion, 21C, 23B Vent hole, 22 Rupture plate, 22A Vent portion, 23A Opening portion, 24 Gasket, 28 Grooved portion, 29 Shoulder portion, 31 Circumferential edge portion, 39 Tip portion of outer can, 40 Corner portion of outer can, 41 Facing portion of gasket, 42 Annular groove of gasket, 45 Outer circumferential end of sealing assembly, 46 Upper surface of circumferential edge portion of sealing assembly, 50 Cylindrical portion of gasket, 51 Circular portion of gasket, 51a Thin-walled portion of circular portion, 55 Cover portion, K4 First position, K5 Second position.

1. A gasket for a cylindrical battery, comprising:
a cylindrical portion having an annular groove formed on an outer circumferential surface; and
a circular portion extending inward in a radial direction from one end portion of the cylindrical portion on one side in an axial direction, wherein
when a sealing assembly of the cylindrical battery is mounted on the gasket so as to be in contact with the circular portion, the annular groove is provided within a range from a first position to a second position in the cylindrical portion, the first position corresponding to another side surface of a circumferential edge portion of the sealing assembly, the second position being 1 mm away toward the other side from the first position, in the axial direction.

2. A cylindrical battery, comprising:
an electrode assembly having a positive electrode and a negative electrode wound through a separator;
a bottomed cylindrical outer can that houses the electrode assembly; and
a sealing assembly that is crimped and fixed to an opening portion of the outer can through a gasket, wherein
the gasket has an annular groove provided in a range including at least part of a facing portion that faces a corner portion of the outer can, the corner portion being adjacent to a tip portion extending inward in a radial direction.

3. The cylindrical battery according to claim 2, wherein the annular groove is provided in the facing portion.

4. A cylindrical battery manufacturing method, comprising crimping the gasket according to claim 1 between a sealing assembly and an outer can.
